(19) United States
(12) Patent Application Publication
(10) Pub. No.: US 2015/0376499 A1
(43) Pub. Date: Dec. 31, 2015

(54) BINDER FOR SELF-COMPACTING AND RE-EXCAVATABLE BACKFILL

(71) Applicant: ETABLISSEMENTS HUBLET, Floreffe (BE)

(72) Inventor: Aurélien Nonet, Lesve (BE)

(73) Assignee: ETABLISSEMENTS HUBLET, Floreffe (BE)

(21) Appl. No.: 14/766,418

(22) PCT Filed: Feb. 6, 2014
(86) PCT No.: PCT/EP2014/052341

§ 371 Date: Aug. 6, 2015

(30) Foreign Application Priority Data
Feb. 6, 2013 (BE) 2013/0082

(51) Int. Cl. C09K 17/52; C04B 7/32; C09K 17/42; C04B 7/26; E02D 3/00; E02D 3/12

(52) U.S. Cl. CPC C09K 17/52; E02D 3/005; E02D 3/126; E02D 3/123; C09K 17/42; C04B 7/26; C04B 7/32

(57) ABSTRACT

A hydraulic binder composition intended to be used to form a self-compacting and re-excavatable backfill, said hydraulic binder composition comprising fly ash, aluminous cement, and hydrated lime, said hydraulic binder composition being intended to be mixed with a granulate composition and with water to form said self-compacting and re-excavatable backfill.

The present invention relates to a binder composition of a self-compacting and re-excavatable backfill with fast setting of class 1 (MAR 1) or 2 (MAR 2) according to the guide Qualiroute version 2012 of the Belgian Walloon Region. More specifically, this binder composition is intended to be used for making a backfill for example used within the scope of backfilling trenches of different types such as for example excavation trenches or trenches for connecting to water, gas, electricity, telephone networks, etc, said backfill may be achieved both on roads and on road sides.

Presently, self-compacting backfills existing on the market which allow fast return to traffic (for example motorway traffic) of the treated road segment, for example a road or a motorway, use two different principles (one, the other or a combination of both):
1) A larger amount of binder (generally of the cement type Portland®, often CEM I 52,5R); and
2) Improvement of the bearing capacity made by draining a significant portion of the water in the surrounding medium, which classifies them among the MARs of the drainable type.

Unfortunately, the addition of a larger amount of binder, i.e. the use of more than 50 kg of cement per m³ of backfill generally causes leaving of the finished product (i.e. the backfill) from class 1 (this is referred to as MAR 1), sometimes even from the class 2 (MAR 2) of re-excavatability.

A consequence is that it is no longer guaranteed that the networks covered by the aforementioned type of backfill may be cleared subsequently without being subject to damages. Further, the delays required for the setting of this type of backfill is always of the order of two to three hours for the present versions with rapid setting.

Moreover, a drainage step, which further is only possible if the medium on which the backfill operations is carried out, is drainable, is generally slow, and which is not very favorable to a backfill method which has to be achieved within a short lapse of time (so that for example a treated road segment is rapidly returned (within a delay from 2 to 12 hours) to traffic) and that perturbations related to the backfill operating sites are limited in time.

The object of the invention is to overcome the drawbacks of the state of the art by providing a binder composition allowing the making of a self-compacting and re-excavatable backfill having fast setting, easy re-excavatability as well as increased efficiency both in a drainable medium (permeable) and in a non-drainable (impermeable) medium.

By the terms of <<fast setting>> in the sense of the invention is meant the capability within a time lapse of maximum 60 minutes, preferably within a delay comprising 20 and 40 minutes after applying the backfill, of attaining a bearing capacity greater than 17 MPa as measured by a plate test [a measurement method of the C.R.R. (Roadwork Research Centre—Belgium)—MR 40/78 published in 1978].

By the terms of <<easy re-excavatability>>, should be meant a backfill of class MAR 1 or MAR 2, i.e. for which the crushing value of cubes is less than 0.7 MPa for class 1 or comprised between 0.7 and 2 MPa for class 2. Preferably, this value is comprised between 0.3 and 0.6 MPa. The crushing value, corresponding to the failure load, being measured on cubes 28 days after applying the backfill and kept at a temperature of 20° C.±4° C. and at a relative humidity of air of 50%±10%.

By the term of <<increased efficiency even in a non-drainable medium>>, is meant that the treated road segment has attained required and sufficient performances so as to be then returned to traffic within a delay of a maximum of 60 minutes, preferably without requiring a step for draining the backfill: i.e. without an amount of water of more than 15 L per m³ of backfill having to be absorbed by the soil or artificially removed (i.e. by human action, for example by draining or pumping).

In order to solve this problem, according to the invention a hydraulic binder composition is provided intended to be used for forming a self-compacting and re-excavatable backfill, said hydraulic binder composition comprising:
flying ashes in a content comprised between 65% by weight and 95% by weight, preferably between 70% by weight and 90% by weight, advantageously between 75% by weight and 85% by weight, on the basis of the total weight of the hydraulic binder composition;
aluminous cement in a content comprised between 5% by weight and 35% by weight, preferably between 15% and 20% by weight, on the basis of the total weight of the hydraulic binder composition;
hydrated lime in a content comprised between 0.05% by weight and 15%, preferably between 0.5% by weight and 6% by weight, advantageously between 1% by weight and 5% by weight, on the basis of the total weight of the hydraulic binder composition,
   the hydraulic binder composition being intended to be mixed with a composition of granulate and with water in order to form the self-compacting and re-excavatable backfill.

By the term of <<granulate composition>>, in the sense of the present invention, is meant a plurality or a mixture of a plurality of particles and/or of grains of granulates of sand, gravel and of stones making up mortars and concretes.

By the term of <<grain>>, in the sense of the present invention, is meant an aggregate or an agglomerate of particles.

An aggregate is defined within the scope of the present invention as being a set of atoms and/or molecules connected together through strong cohesion forces, i.e. by forces of the hydrogen bond type, cohesion forces of the covalent type or forces of the ionic type. It must further be understood that said aggregate may be formed by the action of at least one strong cohesion force between the particles.

An agglomerate of particles is an assembly of a set of atoms and/or molecules connected together by strong cohesion forces i.e. by forces of the Van der Waals type. Further it should be understood that said agglomerate may be formed by the action of at least one of these weak cohesion forces between the particles.

Within the scope of the present invention, it was surprisingly observed that the binder both plays the role of a lubricant between the particles and/or the grains of the granulate composition making up the backfill and the role of a binder between the particles by the hydraulic setting phenomena at the origin of the setting and therefore of the mechanical strength of the backfill formed with the hydraulic binder composition according to the invention.

Thus, on one side, the hydraulic binder composition according to the invention, because of its lubricating property, gives the possibility of obtaining a backfill for which subsequent re-excavation may be easily carried out: A backfill of class MAR 1 or 2 of the non-drainable type (when the backfill is capable of setting even when it is placed in a medium impervious to water) is thereby obtained.

The obtaining of a backfill of class MAR 1 or 2 is all the more advantageous since the re-excavation of said backfill is carried out in the vicinity of coated cables and ducts, particular working conditions in which the re-excavation of the backfill should require accurate execution and for this an execution as less motor-driven as possible, or even manual execution.

On another side, because of its setting with water, the hydraulic binder composition gives the possibility of obtaining a backfill of class MAR 1 or 2 in a particularly short delay, allowing fast return to traffic of the treated road segment: This backfill then meeting the criteria of a bearing capacity value greater than or equal to 17 MPa after setting of the backfill and an Abrams cone collapse value greater than or equal to 24 cm before setting of the backfill.

Alternatively, the hydraulic binder composition comprises hydrated lime in a content comprised between 1% by weight and 15% by weight, preferably between 7% by weight and 15% by weight, based on the total weight of the aluminous cement and of hydrated lime.

The role of the hydrated lime is to accelerate the hydraulic setting of the aluminous cement.

Advantageously, the hydraulic binder composition is characterized in that said flying ashes has a grain size curve characterized by a d₅₀ comprised between 0.04 mm and 0.125 mm.

Within the scope of the present invention, a d₅₀ for example equal to 0.04 mm represents an 80% weight fraction of flying ashes (based on the total weight of the flying ashes) which has particles and/or grains for which the diameter is less than 0.04 mm.

Optionally, the hydraulic binder composition is characterized in that said flying ashes has a volume density of 2.31×10³ kg/m³±0.20×10³ kg/m³.

Preferably, 100% of the hydraulic binder composition according to the invention consists of flying ashes, aluminous cement and hydrated lime.

In particular, the hydraulic binder composition appears in a powdery form.

However, the hydraulic binder composition may additionally comprise at least one superplasticizer and/or water.

Preferably, said superplasticizer, water, flying ashes, aluminous cement and hydrated lime represent 100% of the weight of the hydraulic binder composition.

Alternatively, the hydraulic binder composition comprising water appears as a slurry.

In a particular embodiment, the hydraulic binder composition is characterized in that it comprises at least one superplasticizer preferably selected from the group of polycarboxylic derivatives, advantageously derivatives of polycarboxylic ether, said at least one superplasticizer being present in a dry extract content comprised between 2.7×10⁻⁴% by weight and 3.4×10⁻³% by weight based on the total weight of the hydraulic binder composition.

By the terms “dry extract”, it should be understood within the sense of the present invention, an anhydrous superplasticizer.

The role of the superplasticizer is to reduce the amount of water required for producing the backfill.

Other embodiments of the hydraulic binder composition according to the invention are indicated in the appended claims.

The present invention moreover deals with a backfill composition comprising a granulate composition and the hydraulic binder composition according to the invention.

This backfill composition is ready to be mixed with water, preferably mixed with water, in order to form said self-compacting and re-excavatable backfill: This is referred to as setting or hydraulic setting of the backfill.

In a preferential embodiment, the composition comprises a granulate composition in a content comprised between 80% by weight and 95% by weight, preferably between 80.5% by weight and 95% by weight based on the total weight of said backfill composition, and the hydraulic binder composition according to the invention in a content comprised between 4% by weight and 14% by weight, preferably between 6% by weight and 10% by weight, based on the total weight of said backfill composition.

The backfill composition may optionally be completed with water or other additives such as for example air entrainers.

Optionally, the backfill composition according to the invention comprises a granulate composition having a grain size curve centred on the grading range defined by the following Fuller and Thompson equation:

$$p = 100 {( \frac{d}{D} )}^{n}$$

wherein:

p represents the run-through fraction (in % based on the total weight of the granulate composition) of the weight of particles and/or of granulates or sand grains;

d represents the size (in mm) of the meshes of the sieve; D represents the maximum diameter (in mm) of the particles and/or of the granulate grains and is comprised between 5 and 10 mm;

N is an experimental factor selected in a range of values comprised between 0.30 and 0.55.

In a particular embodiment of the present backfill composition, these parameters are set as follows:

d is comprised between 0 mm and 12.5 mm;

D has the value 10 mm; and

n is set to 0.40.

For this particular embodiment, the values of d and p are for example the following:

| | P | | |
|---|---|---|---|
| d | p^{§} | p MIN (%)* | p MAX (%)** |
| 14 | 100 | | |
| 10 | 100 | 85 | 100 |
| 8 | 91.5 | 76.5 | 100 |
| 6 | 81.5 | 66.5 | (between 91.5 and 100) |
| 5 | 75.8 | 60.8 | (between 85.8 and 90) |
| 4 | 69.3 | 54.3 | 79.3 |
| 2 | 52.5 | 37.5 | 62.5 |
| 1 | 39.8 | 24.8 | 49.8 |
| 0.5 | 30.2 | 15.2 | 40.2 |
| 0.2 | 20.9 | 5.9 | 30.9 |
| 0.063 | 13.2 | 0 | 23.2 |

^{§}The run-through fraction (in % based on the total weight of the granulate composition) of the weight of particles and/or granulate or sand grains.
*The minimum run-through fraction (in % based on the total weight of the granulate composition) of the weight of particles and/or granulate or sand grains (preferably, p MIN = p − 15, with p MIN greater than or equal to 0).
**The maximum run-through fraction (in % based on the total weight of the granulate composition) of the weight of particles and/or granulate or sand grains (preferably p MAX = p + 10, with p MAX less than or equal to 100).

Preferably, p is comprised between 0 and 100, and advantageously has a value comprised between the value of p MIN and the value of p MAX.

Advantageously, the backfill composition comprises a granulate composition having a particle and/or grain size distribution characterized by a d₁₀₀ comprised between 6 mm and 17 mm, d₉₅ between 5 mm and 12 mm, d₅₀ between 1 mm and 5 mm, and d₃₀ between 0.3 mm and 1 mm.

Preferably, the backfill composition comprises a granulate composition having a particle and/or grain size distribution characterized by a d₇₀ comprised between 3 and 7 mm.

In a preferential embodiment, the backfill composition comprises a granulate composition having a particle and/or grain size distribution characterized by a d₃₀ comprised between 0.3 and 0.9 mm.

Preferentially, the granulate composition has a particle and/or gain size distribution characterized by a d₂₀ comprised between 0.1 and 0.5 mm.

Within the scope of the present invention, the notation dₓ represents a diameter, expressed in mm, on the basis of which X % by weight (based on the total weight of the granulate composition) of the measured particles and/or grains are smaller.

Advantageously, the granulate composition comprises particles and/or grains which are natural sand, crushed sand, quarry granulates as well as recycled granulates, or one of their mixtures.

Preferably, the granulate composition comprises particles and/or grains which are one of the following mixtures:
natural sand/crushed sand;
natural sand/quarry granulates;
natural sand/recycled granulates;
crushed sand/quarry granulates;
crushed sand/recycled granulates;
quarry granulates/recycled granulates;
natural sand/crushed sand/quarry granulates;
natural sand/crushed sand/recycled granulates;
quarry granulates/recycled granulates/natural sand; or
quarry granulates/recycled granulates/crushed sand.

Other embodiments of the backfill composition according to the invention are indicated in the appended claims.

The present invention further deals with a self-compacting and re-excavatable backfill comprising said backfill composition according to the invention and water.

Preferably, the water is added to said backfill composition in a content comprised between 6% and 15% by weight, preferably between 7% and 8% by weight, ideally 7.1% by weight based on the total weight of said backfill composition.

The backfill according to the invention may further comprise at least one superplasticizer, preferably selected from the group of polycarboxylic derivatives, advantageously derivatives of polycarboxylic ether, said at least one superplasticizer being present in a content comprised between 0.1 L and 1.0 L per m³ of backfill.

Other embodiments of the backfill according to the invention are indicated in the appended claims.

Within the scope of a useful backfilling for roads, the invention also deals with a method for making a self-compacting and re-excavatable backfill according to the invention, comprising the following steps:
providing a first predetermined volume (V1) of a granulate composition into a kneading chamber having a second predetermined volume (V2);
providing a third volume (V3) of a mixture of said hydraulic binder composition and the water or of an aqueous phase; and
kneading said granulate composition, water or aqueous phase, and of said hydraulic binder composition in order to form said self-compacting and re-excavatable backfill.

Preferably, the method comprises, before the step for providing said third volume (V3), a step for measuring a volume difference (ΔV) between said predetermined volume (V2) and said first predetermined volume (V1), said third volume (V3) and the volume difference (ΔV) being present in a (V3)/(ΔV) ratio comprised between 0.75 and 1.5.

Alternatively, said third volume (V3) is at least equal to said measured volume difference (ΔV).

Advantageously, said first step of this method is preceded with a step for forming said granulate composition by providing at least two granulates, each granulate being provided at a pre-determined volume, in order to form said first volume (V1) of said granulate composition.

Optionally, said first step of this method is preceded with a step for forming said third volume (V3) of a slurry of the binder composition by mixing said hydraulic binder composition with water or an aqueous phase.

Preferentially, the water (or the aqueous phase) and said hydraulic binder composition are provided separately in the kneading chamber.

Alternatively, the water (or the aqueous phase) is brought in the supply of granulate, into said kneading chamber, to said backfill composition, or further in said supply of the hydraulic binder composition.

Optionally, at least one superplasticizer is further added to said granulate composition, to said hydraulic binder composition or to the water or still separately in the kneading chamber.

Advantageously, the aforementioned steps are carried out simultaneously.

The method further comprises a step for placing said self-compacting and re-excavatable backfill in trenches.

Other embodiments of the method according to the invention are indicated in the appended claims.

Further, the present invention deals with the use of the hydraulic binder composition according to the invention for forming a self-compacting and re-excavatable backfill, said hydraulic binder composition being intended to be mixed with a granulate composition and with water in order to form said self-compacting and re-excavatable backfill.

Other embodiments of this use according to the invention are indicated in the appended claims.

The present invention also deals with the use of the backfill composition according to the invention for forming a self-compacting and re-excavatable backfill, said backfill composition being intended to be mixed with water in order to form said self-compacting and re-excavatable backfill.

Other embodiments of this use according to the invention are indicated in the appended claims.

Further, other features, details and advantages of the invention will become apparent from the description given hereafter, in a non-limiting way.

### Preferential Composition of the Hydraulic Binder Composition

In a preferential embodiment of the hydraulic binder composition according to the present invention, the latter appears as a slurry comprising:

(i) flying ashes;

(ii) aluminous cement;

(iii) water; and optionally

(iv) hydrated lime; and/or alternatively

(v) at least one superplasticizer additive.

The flying ashes are an industrial byproduct.

The role of the flying ashes is to ensure fluidity to the hydraulic binder composition between the moment when the latter is produced and the beginning of the setting, i.e. once mixed with the granulate composition.

The grain size curve of the flying ashes comprises a fraction of 20%±10% by weight based on the total weight of the flying ashes, for which the particles or grains of ashes have a diameter greater than 0.04 mm.

The volume density of the flying ashes is 2.31±0.20 metric tons per m³.

Preferentially, the fraction of flying ashes expressed in kg per m³ of backfill to be produced is comprised between 65 kg/m³ and 225 kg/m³.

The aluminous cement, also called molten cement, of the hydraulic binder composition meets the EN14647 standard of 2005 and is present in an optimal content of 24.9 kg per m³ of obtained backfill.

The aluminous cement content is comprised between 15.0 kg and 45.0 kg per m³ of backfill. Such a range of values for the aluminous cement content gives the possibility of obtaining a bearing capacity performance of 17 MPa in the roadway bearing capacity test on the plate [measurement method of the C.R.R. (Roadwork Research Centre—Belgium)—MF 40/78] in a lapse of time comprised between 5 minutes and 60 minutes, while limiting crushing strength, characterized by the crushing in a laboratory of a cube with a side of 15 cm±1 cm, at a value of less than or equal to 0.7 MPa for an MAR 1 strength class or at 2.0 MPa for a MAR 2 strength class.

The hydrated lime present in the hydraulic binder composition is preferably powdery lime.

The hydrated lime content depends on the aluminous cement content.

Preferably, the hydraulic binder composition comprises hydrated lime in a content comprised between 7% by weight and 15% by weight based on the total weight of aluminous cement and of hydrated lime.

The hydraulic binder composition comprises 11% of lime based on the total weight of aluminous cement and of hydrated lime.

In order to obtain the desired fluidity, it is further possible to incorporate into the hydraulic binder composition a superplasticizer highly reducing water from the family of polycarboxylates, like polycarboxylic ethers. For examples, the superplasticizer may be ViscoCrete 10200 or ViscoCrete 2200HE® from Sika. The dosage of superplasticizer is comprised between 0.2 L and 1.0 L per m³ of backfill, ideally between 0.3 L and 0.5 L per m³ of backfill, with a dry extract content of 34% by volume of superplasticizer.

The dosage, reduced to polycarboxylates concentrated to 100% therefore corresponds to a range of values comprised between 0.06 kg and 0.35 kg preferably between 0.10 kg and 0.17 kg per m³ of backfill.

As pointed out earlier, the use of one or several superplasticizer additives gives the possibility of reducing the amount of water required for making the backfill.

Optionally, water may be added to the powdery hydraulic binder composition in order to form a slurry.

However, one should make sure that the amount of water added to the powdery composition does not exceed a required and sufficient amount for ensuring an Abrams cone collapse of the backfill of more than or equal to 24 cm.

Depending on the amount of hydraulic binder composition as well as on the amount and of the chemical nature and/or grain size characteristics of the granulate composition, as well as on the water content of the granulate composition, the amount of water added to the powdery hydraulic binder composition is comprised between 50 L and 200 L per m³ of backfill.

### Preferential Backfill Granulate Composition

The granulate composition, further called within the scope of the present invention, the “backfill granulate” may comprise a natural granulate or a recycled granulate, or a mixture of both. Further, the backfill granulate is preferably a mixture of several granulates or of at least one sand and of at least one granulate, each sand and each granulate having a specific grain size curve.

In this context, the grain size curve of the backfill granulate [measured under dry conditions according to the standard Qualiroute version 2012—CME 01.01—ANALYSE GRANULOMETRIQUE DES SOLS: METHODE PAR TAMISAGE ET METHODE AREOMETRIQUE (GRAIN SIZE ANALYSIS OF SOILS: SIEVING METHOD AND AREOMETRIC METHOD)] consists of several specific grain size curves in order to obtain a continuous grain size comprised in the following range:

| | | |
|---|---|---|
| Mesh size | MIN run- | MAX run- |
| (d in mm) | through (%)* | through (%)** |

| | |
|---|---|
| 17 | 100 |

| | | |
|---|---|---|
| 10 | 85 | 100 |
| 6 | 60 | 700 |
| 5 | 50 | 95 |
| 3 | 40 | 70 |
| 1 | 30 | 50 |
| 0.5 | 20 | 40 |

*Minimum run-through fraction (in % based on the total weight of the granulate composition) of the weight of particles and/or of granulate or said grains.
**Maximum run-through fraction (in % based on the total weight of the granulate composition) of the weight of particles and/or granulate or said grains.

This grain size curve may be produced with quarry granulates, natural sand, recycled granulates, concrete recycled granulates, crushing sand, synthetic granulates or synthetic sands.

The grain size curve of the granulate should not contain any particles and/or grains for which the diameter is greater than 40 mm. Ideally, the grains or particles have a maximum diameter comprised between 5 mm and 15 mm. Optimally, the particles and/or the grains have a maximum diameter comprised between 5 mm and 10 mm.

Preferably, the maximum diameter of the particles and/or grains of the granulate is less than or equal to 10 mm for natural granulate and is less than or equal to 15 mm for a recycled granulate comprising small bricks. It should be noted that for higher diameters of particles and/or grains, it is difficult or even impossible to subsequently re-excavate the backfill obtained by manual means (de facto one passes from a backfill of class MAR 1 or 2 to a backfill of class MAR 2 or 3).

The grain size curve of the particles or grains is selected so as to limit as much as possible the required amount of hydraulic binder composition in order to fill the space generated between the particles and/or the grains of the backfill granulate.

Preferably, the grain size curve of the backfill granulate is selected so that it is centred on the grain size range defined by Fuller and Thompson's equation (the parameter n of which is comprised between 0.30 and 0.55).

The more the grain size profile of the granulate composition approaches the selected Fuller and Thompson curve, the more the optimum density of the mixture of granulates making up the granulate composition is approached, which is sought. Therefore sand and granulates are mixed in order to attain this goal.

The different constituents which may be used for producing the backfill granulate are the following:

(i) a mixture of various natural sands;

(ii) a mixture of various sands and recycled granulates;

(iii) a mixture of various natural granulates (crushed or rolled);

(iv) a mixture of various recycled granulates (concrete debris, natural stone or mixed debris);

(v) a mixture of various artificial granulates; or

(vi) at least a combination of the aforementioned mixtures.

Preferentially, the backfill granulate comprises at least one type of sand and at least one type of granulate. For each sand/granulate pair for which a specific grain size curve is selected, it will be necessary to adapt the composition and the amount of the hydraulic binder composition in order to attain the grain size curve of the backfill, desired beforehand.

### Methods for Making the Backfill and Applying it

By the terms of “manufacturing methods”, is meant in the sense of the present invention, a first and a second method for manufacturing a self-compacting and re-excavatable backfill.

This manufacturing method comprises the following steps:
providing a first predetermined volume (V1) of a granulate composition in a kneading chamber having a predetermined second volume (V2);
providing a third volume (V3) of a mixture of said hydraulic binder composition and of water or aqueous phase; and
kneading said granulate composition, water and of said hydraulic binder composition in order to form said self-compacting and re-excavatable backfill.

Preferably, the method comprises, prior to the step for providing said third volume (V3), a step for measuring a volume difference (ΔV) between said second predetermined volume (V2) and said predetermined first volume (V1), said third volume (V3) and the volume difference (ΔV) being present in a (V3)/(ΔV) ratio comprised between 0.75 and 1.5.

Alternatively, said third volume (V3) is at least equal to said measured volume difference (ΔV).

Advantageously, said first step of this method is preceded with a step for forming said granulate composition by providing at least two granulates, each granulate being brought at a pre-determined volume, in order to form said first volume (V1) of said granulate composition.

Optionally, said first step of this method is preceded with a step for forming said third volume (V3) of a slurry of the binder composition by mixing said hydraulic binder composition with water or an aqueous phase.

Preferentially, the water and said hydraulic binder composition are provided separately in the kneading chamber.

Alternatively, the water or the aqueous phase is brought in the supply of the granulate, into said kneading chamber, to said backfill composition, or further in said supply of the hydraulic binder composition.

Optionally, at least one superplasticizer is further added to said granulate composition, to said hydraulic binder composition, or to water (or to the aqueous phase), or further separately in the kneading chamber.

Advantageously, the aforementioned steps are carried out simultaneously.

As an illustration, the granulate composition may be optimized beforehand in the following way: If this granulate composition does not have a desired grain size curve, it is necessary to produce for example a mixture of sand and gravel so that the granulate composition which results from this mixture has a grain size profile which approaches the optimum theoretical grain size curve defined by Fuller and Thompson for a set value of n within the scope of this example to 0.40 and a value of D of 10 mm.

In this context, the mixture of the granulate and of the sand, and therefore the granulate composition is optimized in order to limit the empty volume (ΔV).

The ideal dosage of the third volume comprising the hydraulic binder composition and the mixing water is 1.05×(ΔV), but may be selected in the range from 0.75×(ΔV) to 1.50×(ΔV).

The time for handling the fresh product being of the order of a few minutes, the material should be produced and applied on the site of use, as close as possible to the excavation or to the trench to be backfilled.

The aforementioned method further comprises a step for placing said self-compacting and re-excavatable backfill in trenches.

The application of the backfill according to this first manufacturing method may take two preferential routes:

1) Continuous Manufacturing on Site

A movable system, which may be fixably or movably mounted on a truck or a trailer and which contains all the constituents entering the manufacturing of the backfill as well as the dosage and preparation systems.

The various constituents of the backfill are simultaneously introduced at the entry of a continuous kneader so as to obtain the desired formulation. At the outlet of this kneader, the mixture is directly poured into the trench or the excavation to be backfilled. Within the scope of use of a continuous kneader, it is important to simultaneously introduce all the constitutive elements of the backfill, in proportions required beforehand: The dosage of the different constituents of the backfill may actually be modulated and may consequently be adapted to the type of trench which has to be backfilled.

Thus, depending on the physico-chemical composition of the particles and/or of the grains making up the backfill granulate and on the desired backfill class, the fractions of the components of the hydraulic binder composition, the granulate fraction of the backfill, and the water fraction have to be adjusted.

It is further possible to produce pre-mixes such as:
(i) mixture of granulate and of sand;
(ii) mixture of granulate with a mixture of sand and aluminous cement;
(iii) mixture of granulate with a mixture consisting of sand, aluminous cement and hydrated lime;
(iv) mixture of water and of at least one superplasticizer additive;
(v) mixture of water and of hydrated lime; and
(vi) mixture of water with a mixture of at least one superplasticizer additive and of hydrated lime.

The dwelling time in the kneading chamber of the continuous kneader which is less than 2 minutes, is ideally less than 1 minute.

2) Pre-Mixing the Constituents of the Backfill at the Works and Producing the Mixture of the Constituents on Site

The question is then to prepare on a site different from that of the application (for example at the factory) two mixtures: on one side, a mixture of various granulates is achieved in order to produce a backfill granulate having a defined grain size curve. On another side, the question is to prepare a mixture of binder composition and optionally of one or several superplasticizer additives. Once on site, water and both of these mixtures are introduced into a kneading device in predefined respective contents. This kneading device may be a cement mixer, a planetary gear kneader or further a continuous kneader (see the manufacturing method 1).

After its manufacturing, the backfill should be immediately applied. It may be directly poured at the outlet of the kneading chamber into the excavation or connection trench to be backfilled, pumped, or further transported by a skip, an Archimedes' screw, or a belt.

However, for each of these aforementioned embodiments, one should make sure that the handleability is always sufficient upon arriving of the mixture in the area to be backfilled.

A specific production method is the use of a central, volumetric or weight truck. It contains one to two hoppers laid out for receiving the backfill granulate (or its constituents), and from one to three silos giving the possibility of receiving the hydraulic binder composition or its constituents, or a premix of the latter. The different constituents of the backfill are provided by means of an Archimedes' screw and/or one or several belts at the inlet of the kneader, just like water and the optional additives. The different constituents are then kneaded and then poured into the excavation or connection trench to be backfilled.

Performances and Time-Dependent Change in the Strengths

The two main characteristics of the backfill which were tracked are the following:
i) characterization of the bearing capacity by plate test (measured in MPa); and
ii) characterization of the re-excavatability, by crushing test cubes (measured in MPa).

The usual plate test values are the following:
a) a value greater than or equal to 17 MPa obtained within 60 minutes after application, ideally within less than 30 minutes after application;
b) a time-dependent change, measured at 120 minutes and 180 minutes, of the plate test value preferably greater than 25 MPa, preferably comprised in the range of values defined between 25 and 60 MPa; and
c) an acceptable threshold value for crushing cubes which should not be exceeded, is measured at 28 days and is set to 0.7 MPa for a backfill of class 1 (MAR 1).

During its application, the backfill is fluid. Its Abrams cone collapse value is greater than or equal to 24 cm.

The applied backfill by means of a movable central system REIMER of the RA-850 type mounted on a truck with four axles.

A few minutes after its application, the backfill sets, it should no longer be set into motion to the penalty of having reduced performances.

Within the scope of the present invention, after a delay of 60 minutes after applying the backfill a bearing capacity value measured by means of a plate test (C.R.R. standard MF 40/78), greater than or equal to 33.0 MPa was observed and this, while observing a strength value upon free collapse of a cube with sieves of 15 cm of 0.47 MPa within a delay of 28 days after application, or comprised between 0.38 and 0.55 MPa within the 28 day delay.

These performances are attained in a non-drainable re-excavation medium saturated with water for a backfill having a density of 2.139 kg/m³ consisting of the following constituents per m³ of backfill:
1) Granulate composition having a humidity level of 4% (by weight) consisting of:
   a) 1,123 kg/m³ of a quarry gravel granulate with a continuous grain size curve comprised within the following range:

| Mesh size | Total run- |
|---|---|
| (d in mm) | through* (%) |
| 12.5 | 100 |
| 11.2 | 100 |
| 10 | 100 |
| 9 | 100 |
| 8 | 95 |
| 7.1 | 87 |
| 6.3 | 76 |
| 5 | 50 |
| 4 | 30 |
| 3.15 | 17 |
| 2 | 4 |
| 1 | 1 |
| 0.5 | 0 |
| 0.2 | 0 |
| 0.063 | 0 |
| 0 | 0 |

*Total run-through fraction (in % based on the total weight of the granulate composition) of the weight of particles and/or granulate or sand grains.

b) 813 kg/m³ of river sand with a continuous grain size curve comprised within the following range:

| Mesh size | Total run- |
|---|---|
| (d in mm) | through* (%) |
| 12.5 | 100 |
| 11.2 | 100 |
| 10 | 100 |
| 9 | 100 |
| 8 | 100 |
| 7.1 | 99 |

*Total run-through fraction (in % based on the total weight of the granulate composition) of the weight of particles and/or of grains of granulate or sand grains.

2) 156 kg/m³ of a hydraulic binder composition (i.e. 7% by weight based on the weight of the backfill composition comprising the gravel/sand/hydraulic binder composition mixture) comprising:
   a) Flying ashes: 128 kg/m³ (i.e. 82% by weight based on the total weight of the hydraulic binder composition);
   b) Aluminous cement: 24.9 kg/m³ (i.e. 16% by weight based on the total weight of the hydraulic binder composition);
   c) hydrated lime: 3.1 kg/m³ (i.e. 2% by weight based on the total weight of the hydraulic binder composition); and optionally
   d) fluidifier (Sika 10200): 0.4 L/m³.
   3) 95 L/m³ of water added in the presence of fluidifier; or
   4) 120 L/m³ of water added in the absence of fluidifier.

It is quite understood that the present invention is by no means limited to the embodiments described above and that many modifications may be provided thereto without departing from the scope of the appended claims.

1. A hydraulic binder composition intended to be used for forming a self-compacting and re-excavatable backfill, comprising:
flying ashes in a content comprised between 65% by weight and 95% by weight, preferably between 70% by weight and 90% by weight, advantageously between 75% by weight and 85% by weight, based on the total weight of the hydraulic binder composition; and
aluminous cement in a content comprised between 5% by weight and 35% by weight, preferably between 15% and 20% by weight, on the basis of the total weight of the hydraulic binder composition;
hydrated lime in a content comprised between 0.05% by weight and 15%, preferably between 0.5% by weight and 6% by weight, advantageously between 1% by weight and 5% by weight, on the basis of the total weight of the hydraulic binder composition,
said hydraulic binder composition being intended to be mixed with a granulate composition and with water in order to form said self-compacting and re-excavatable backfill.

2. The hydraulic binder composition according to claim 1, wherein said flying ashes have a grain size curve characterized by a d₈₀ comprised between 0.04 mm and 0.125 mm.

3. The hydraulic binder composition according to claim 1, wherein said flying ashes have a volume density of 2.31×10³ kg/m³±0.20×10³ kg/m³.

4. The hydraulic binder composition according to claim 1, characterized in that it comprises at least one superplasticizer preferably selected from the group of polycarboxylic derivatives, advantageously derivatives of polycarboxylic ether, said superplasticizer being present in a content comprised between 2.7×10⁻⁴% by weight and 3.4×10⁻³% by weight based on the total weight of said binder.

5. The hydraulic binder composition according to claim 1, characterized in that it comprises hydrated lime in a content comprised between 1% by weight and 15% by weight, preferably between 7% by weight and 15% by weight, based on the total weight of aluminous cement and of hydrated lime.

6. The hydraulic binder composition according to claim 1, characterized in that it appears in a powdery form.

7. The hydraulic binder composition according to claim 1, characterized in that it comprises water and appears as a slurry.

8. A self-compacting and re-excavatable backfill composition comprising a granulate composition and said hydraulic binder composition according to claim 1, said backfill composition being ready to be mixed with water in order to form a self-compacting and re-excavatable backfill.

9. The backfill composition according to claim 8, characterized in that it comprises:
said granulate composition in a content comprised between 80% by weight and 95% by weight, preferably between 80.5% by weight and 95% by weight, based on the total weight of said backfill composition; and
said hydraulic binder composition in a content comprised between 4% by weight and 14% by weight, preferably between 6% by weight and 10% by weight, based on the total weight of said backfill composition.

10. The backfill composition according to claim 8, wherein said granulate composition has a grain size curve centered on the grain size range defined by the following Fuller and Thompson equation:
$$p = 100 {( \frac{d}{D} )}^{n}$$
wherein:
p represents the run-through fraction (in % based on the total weight of the granulate composition) of the weight of particles and/or of granulate or sand grains;
d represents the size (in mm) of the meshes of the sieve;
D represents the maximum diameter (in mm) of the particles and/or of the granulate grains and is comprised between 5 and 10 mm;
N is an experimental factor selected in a range of values comprised between 0.30 and 0.55,
characterized in that p is comprised between 0 and 100, and advantageously has a value comprised between:
a value p MIN=p−15, and
a value p MAX=p+10.

11. The backfill composition according to claim 8, wherein the granulate composition has a particle and/or grain size distribution characterized by a d₁₀₀ comprised between 6 mm and 17 mm, d₉₅ between 5 mm and 12 mm, d₅₀ between 1 mm and 5 mm, and d₃₀ between 0.3 mm and 1 mm.

12. The backfill composition according to claim 8, wherein the granulate composition has a particle and/or grain size distribution characterized by a d₇₀ comprised between 3 and 7 mm.

13. The backfill composition according to claim 8, wherein the granulate composition has a particle and/or grain distribution characterized by a d₃₀ comprised between 0.3 and 0.9 mm.

14. The backfill composition according to claim 8, wherein the granulate composition has a particle and/or grain size distribution characterized by a d₂₀ comprised between 0.1 and 0.5 mm.

15. The backfill composition according to claim 8, wherein said granulate composition comprises particles and/or grains which are natural sand, crushing sand, quarry granulates as well as recycled granulates or one of their mixtures.

16. A self-compacting and re-excavatable backfill comprising said backfill composition according to claim 8 and water.

17. A method for manufacturing the self-compacting and re-excavatable backfill according to claim 16, comprising the following steps:
c) providing a predetermined first volume (V1) of a granulate composition into a kneading chamber having a predetermined second volume (V2);
d) providing a third volume (V3) of a mixture of said hydraulic binder composition and of water or an aqueous phase; and
e) kneading said granulate composition, water or aqueous phase, and of said hydraulic binder composition in order to form said self-compacting and re-excavatable backfill, wherein said hydraulic binder composition comprises: flying ashes in a content comprised between 65% by weight and 95% by weight, preferably between 70% by weight and 90% by weight, advantageously between 75% by weight and 85% by weight, based on the total weight of the hydraulic binder composition; and aluminous cement in a content comprised between 5% by weight and 35% by weight, preferably between 15% and 20% by weight, on the basis of the total weight of the hydraulic binder composition; hydrated lime in a content comprised between 0.05% by weight and 15%, preferably between 0.5% by weight and 6% by weight, advantageously between 1% by weight and 5% by weight, on the basis of the total weight of the hydraulic binder composition.

18. The method according to claim 17, comprising, prior to the step for providing said third volume (V3), a step for measuring a volume difference (ΔV) between said predetermined second volume (V2) and said predetermined first volume (V1), said third volume (V3) being at least equal to said measured volume difference (ΔV).

19. The method according to claim 18, wherein said third volume (V3) and the volume difference (ΔV) are present in a (V3)/(ΔV) ratio comprised between 0.75 and 1.5.

20. The method according to claim 17, wherein said first step of this method is preceded with a step for forming said granulate composition by providing at least two granulates, each granulate being provided at a predetermined volume, in order to form said first volume (V1) of said granulate composition.

21. The method according to claim 17, wherein said first step of this method is preceded with a step for forming said third volume (V3) of a slurry of the binding composition by mixing said hydraulic binder composition with water or an aqueous phase.

22. The method according to claim 17, wherein the water or aqueous phase, and said hydraulic binder composition are provided separately into the kneading chamber.

23. The method according to claim 17, wherein the water or aqueous phase is provided in the supply of the granulate, in said kneading chamber, to said backfill composition, or further in said supply of the hydraulic binder composition.

24. The method according to claim 17, wherein at least one superplasticizer is further added to said granulate composition, to said hydraulic binder composition, or to water, or further separately in the kneading chamber.

25. The method according to claim 17, wherein the aforementioned steps are carried out simultaneously.

26. The method according to claim 17, comprising a step for placement of said self-compacting and re-excavatable backfill in trenches.

27. The use of the hydraulic binder composition according to claim 1, for forming a self-compacting and re-excavatable backfill, said hydraulic binder composition being intended to be mixed with a granulate composition and the water in order to form said self-compacting and re-excavatable backfill.

28. The use of the backfill composition according to claim 9, for forming a self-compacting and re-excavatable backfill, said backfill composition being intended to be mixed with water in order to form said self-compacting and re-excavatable backfill.
